(19) United States
(12) Patent Application Publication
(10) Pub. No.: US 2005/0089311 A1
(43) Pub. Date: Apr. 28, 2005

(54) Computer system having direct media access mode

(76) Inventors: Ming-Hou Dai, Chungho City (TW); Jui-Hsiang Yang, Chungho City (TW); Yung-Sung Chao, Chungho City (TW); I-Te Chou, Chungho City (TW)

Correspondence Address: Keith Kline;PRO-TECHTOR INTERNATIONAL SERVICES, 20775 Norada Court, Saratoga, CA, 95070-3018, US

(21) Appl. No.: 10/740,358

(22) Filed: Dec. 17, 2003

(30) Foreign Application Priority Data
Oct. 22, 2003 (TW) 92129351

(51) Int. Cl. H04N 7/26; H04N 5/781

(52) U.S. Cl. 386/109; 386/125; 386/111

(57) ABSTRACT

A computer system having a direct media access mode is described. The computer system has at least a media access mode, a computer, a display, an MPEG decoder, a bus switch, and a controller. The computer system has a computer mode and a direct media access mode. In the computer mode, the computer is turned on and the bus switch switches the bus data from the media access device to the computer for general use. In the direct media access mode, the computer is turned off and the bus switch switches the bus data from the media access device to the MPEG decoder. The MPEG decoder performs decoding and outputs a video stream to be displayed on the display.

### BACKGROUND

1. Field of Invention

The present invention relates to a computer system. More particularly, the present invention relates to a computer system having a direct media access mode.

2. Description of Related Art

Products providing high quality video are prevalent owing to the development of the digital video technology. In the field of digital video, various compression technologies are available to provide the consumers with videos of higher quality at a high compression ratio. Generally speaking, MPEG standards are a common decoding standard, such as MPEG1, MPEG2, MPEG4, or MPEG7. MPEG2 is the standard for DVDs. Because of the high quality of MPEG2, it is prevalent in the market. A DVD player is usually required to play a DVD.

Additionally, with the development of computer technology, a DVD player in cooperation with a computer is realized. Thus, when the computer is turned on, contents of the DVD can be displayed by software decoding. Traditionally, the BIOS and the operation system have to run before the DVD is displayed on the computer. The disadvantages of watching the DVD with the operation system are long boot up time, high power consumption, and low image processing speed.

Traditionally, only a stand-alone DVD player can be instantly turned on for DVD viewing, but a stand-alone DVD player cannot be used by a computer. Therefore, a redundant DVD player has to be used. If the DVD player and the computer display are used and a necessary MPEG decoder is added, the computer system can have the advantage of a stand-alone DVD player and the cost of another DVD player is avoided. There is no need to turn on the computer provided the operation system is not needed. The power consumption is reduced and it is better for the environment.

Therefore, it is valuable to design a computer system, in which when the computer is turned on, the computer system can be used as a general computer and when the computer is turned off, the computer system can be used as a stand-alone DVD player. A DVD can thus be viewed instantly upon turning on the computer.

### SUMMARY

It is therefore an objective of the present invention to provide a computer system having a direct media access mode, in which the video stream is displayed without running the BIOS and the operation system of the computer.

It is another objective of the present invention to provide a computer system having a direct media access mode, in which the computer system uses the same media access device both in the computer mode and in the direct media access mode.

In accordance with the foregoing and other objectives of the present invention, a computer system having a direct media access mode is described. The computer system includes at least a media access device, a computer, a display, an MPEG decoder, a bus switch, and a controller.

The media access device is used to access media data and to output bus data. The MPEG decoder receives the bus data and performs decoding to output a video stream to be displayed on the display. The controller controls the media access device, the MPEG decoder, and the bus switch. The media access device mentioned above is, for example, a DVD player, a VCD player, or a hard disk.

The computer system has a computer mode and a direct media access mode, decided by the controller. In the computer mode, the computer is turned on, the computer system is controlled by the computer and the bus switch switches the bus data to the computer. In the direct media access mode, the computer is turned off, the computer system is controlled by the controller and bus switch switches the bus data to the MPEG decoder.

When the bus data is not compatible with the MPEG standard, the computer system further includes an interface device. The interface device converts the bus data into an MPEG stream compatible with the MPEG standard.

The interface device mentioned above is, for example, an interface for converting Universal Serial Bus data to the MPEG stream or an interface for converting IDE data to the MPEG stream. The MPEG decoder is, for example, an MPEG2, an MPEG4, or an MPEG7 decoder. The controller is, for example, a microprocessor or a FPGA (Field Programmable Gate Array).

Because the invention has a controller and a bus switch, the video stream can be directly displayed without running the BIOS and the operation system of the computer. The invention has a bus switch, so the same media access device is used both in the computer mode and in the direct media access mode.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a preferred embodiment of the invention;

FIG. 2A illustrates an example of the preferred embodiment of the invention; and

FIG. 2B is illustrates another example of the preferred embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

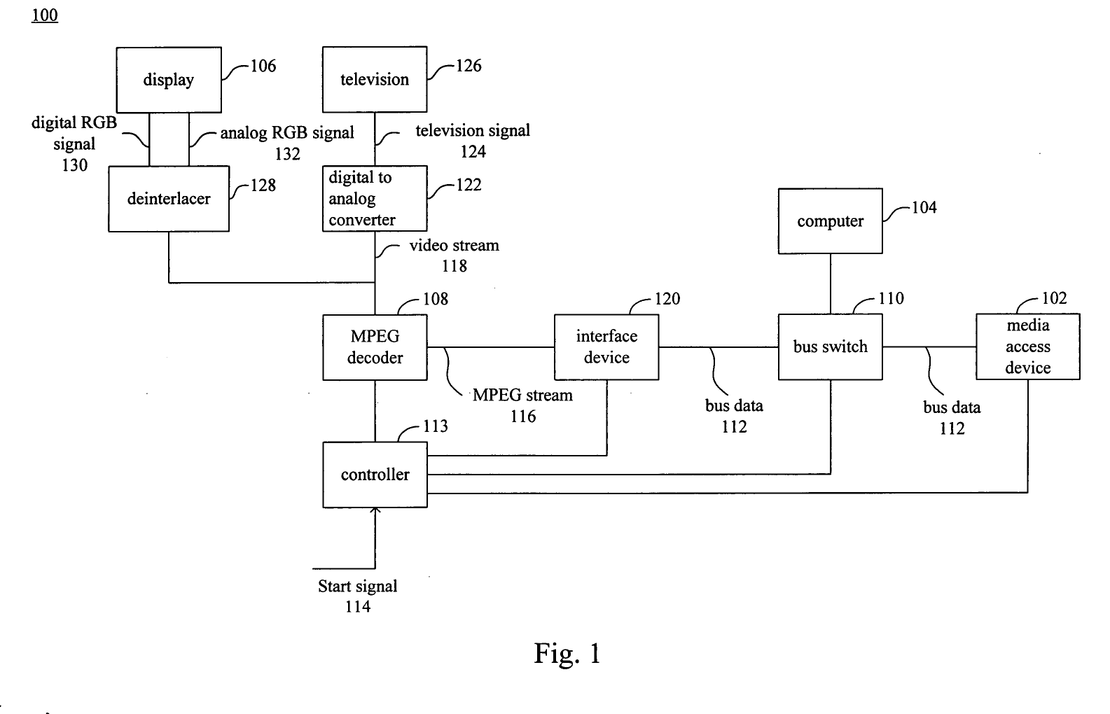

FIG. 1 is a block diagram illustrating a preferred embodiment of the invention. With reference to FIG. 1, the computer system 100 includes a media access device 102, a computer 104, a display 106, an MPEG decoder 108, a bus switch 110, and a controller 113.

The operation of the computer system 100 is described as follows. The controller 113 receives a start signal 114. The controller 113 then provides a computer mode and a direct media access mode for a user to select from. When the computer mode is selected, the computer 104 is turned on and the computer system 100 is controlled by the computer 104. When the direct media access mode is selected, the computer 104 is turned off and the computer system 100 is controlled by the controller 113.

The media access device 102 is used to access a media data and to output a bus data 112. Examples of the media access device 102 include a DVD device, a CD device, a hard disk, and all kinds of storage devices and systems. The DVD device mentioned above is, for example, a DVD player, a DVD+RW, or a DVD-RW.

When the computer mode is selected by a user, the bus switch 110 switches the bus data 112 to the computer 104. At this time, the computer 104 dominates the control and the computer 104 uses the media access device 102 as a general media access device.

When the direct media access mode is selected by a user, the bus switch 110 switches the bus data 112 to the MPEG decoder 108. At this time, the controller 113 dominates the control and the controller 113 controls the media access device 102, the bus switch 110, and the MPEG decoder 108 to work cooperatively. The power of the media access device 102, the bus switch 110 and the MPEG decoder 108 is provided by the spare power of the computer 104.

Next, the MPEG decoder 108 has to receive a bus data 112 compatible with the MPEG standard. If the bus data 112 is compatible with the MPEG standard, the MPEG stream 116 is the bus data 112. If the bus data 112 is not compatible with the MPEG standard, an interface device 120 is needed to convert the bus data 112 into an MPEG stream 116 that is compatible with the MPEG standard. The interface device 120 is, for example, an interface for converting Universal Serial Bus data to the MPEG stream 116 or an interface for converting IDE data to the MPEG stream 116.

Next, the MPEG decoder 108 receives the MPEG stream 116 and performs decoding to generate a video stream 118 to be displayed. The video stream 118 is, for example, a RGB format, an ITU 656 format, an ITU 601 format, or an analog video stream.

As described above, the video stream 118 is directly displayed without running the BIOS and the operation system of the computer 104. The video stream 118 can be displayed on not only a general television 126, but also on a display 106, such as a LCD display. With reference to FIG. 1, the video stream 118 is an interlaced signal. After the interlaced signal is converted by a digital-to-analog converter 122 (DAC), a television signal 124 is generated to be displayed on the television 126. Also, the video stream 118 can be converted by a deinterlacer 128 to generate a digital RGB signal 130 or an analog RGB signal 132 to be displayed on the display 106.

The MPEG decoder 108 mentioned above includes, but is not limited to, an MPEG2 decoder, an MPEG4 decoder, or an MPEG7 decoder. The controller 113 mentioned above is, for example, a CPLD (Complex Programmable Logic Device), a FPGA (Field Programmable Gate Array), or a microprocessor, such as 8051.

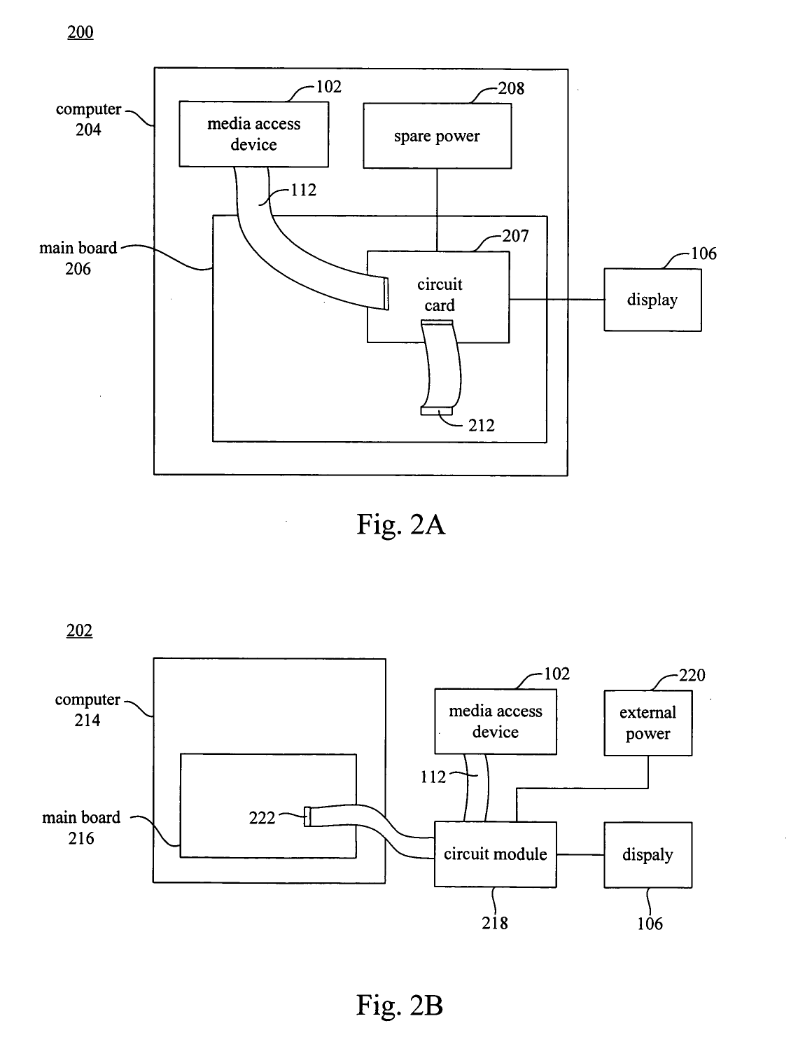

FIG. 2A illustrates an example of the preferred embodiment described above. With reference to FIG. 1 and FIG. 2A, in the computer system 200, the circuit card 207 includes a bus switch 110, an MPEG decoder 108, and a controller 113. The circuit card 207 is fixed on the main board 206 or fixed on another location inside the computer 204. The media access device 102 generates the bus data 112 and sends the bus data 112 to the circuit card 207.

In the computer mode, the circuit card 207 switches the bus data 112 to the computer interface slot 212, such as an IDE interface slot or a USB interface slot. The main board 206 is turned on at this time. The main board 206 uses the media access device 102 as a general media access device.

In the direct media access mode, the bus data 112 is decoded by the MPEG decoder 108 and then sent to the display 106 to be displayed. The main board 206 is turned off at this time. The power of the circuit board 206 is supplied by the spare power 208.

FIG. 2B illustrates another example of the preferred embodiment described above. With reference to FIG. 1 and FIG. 2B, in the computer system 202, the circuit module 218 includes a bus switch 110, an MPEG decoder 108, and a controller 113. The circuit module 218 is used as an external enclosure to be added to the computer 214. The media access device 102 generates the bus data 112 and then sends the same to the circuit module 218.

In the computer mode, the circuit module 218 switches the bus data 112 to the computer interface slot 222, such as an IDE interface slot or a USB interface slot. The main board 216 is turned on at this time. The main board 216 uses the media access device 102 as a general media access device.

In the direct media access mode, the bus data 112 is decoded by the MPEG decoder 108 and then sent to the display 106 to be displayed. The main board 216 is turned off at this time. The power of the circuit module 218 is supplied by an external power 220.

Therefore, in the direct media access mode, the video stream can be directly displayed without running the BIOS and the operation system of the computer. The computer system uses the same media access device both in the computer mode and in the direct media access mode.

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A computer system having a direct media access mode, the computer system comprising:
a display;
a media access device for accessing media data and outputting bus data;
a computer;
an MPEG decoder performing decoding when receiving the bus data and outputting a video stream to be displayed on the display;
a bus switch for receiving the bus data and switching between the computer and the MPEG decoder; and
a controller for controlling the media access device, the MPEG decoder, and the bus switch; wherein:
the computer system has a direct media access mode and a computer mode as decided by the controller;
in the computer mode, the bus switch switches the bus data to the computer;
in the direct media access mode, the bus switch switches the bus data to the MPEG decoder;
in the computer mode, the computer is turned on and the computer system is controlled by the computer; and
in the direct media access mode, the computer is turned off and the computer system is controlled by the controller.

2. The computer system of claim 1, further comprising an interface device placed between the bus switch and the MPEG decoder, wherein when the bus data is not compatible with the MPEG standard, the interface device converts the bus data into an MPEG stream compatible with the MPEG standard.

3. The computer system of claim 2, wherein the interface device comprises an interface for converting Universal Serial Bus data into the MPEG stream.

4. The computer system of claim 2, wherein the interface device comprises an interface for converting IDE data into the MPEG stream.

5. The computer system of claim 1, further comprising a digital to analog converter, the digital-to-analog converter receiving the video stream to generate a television signal to be displayed on a television.

6. The computer system of claim 1, further comprising a deinterlacer, the deinterlacer receiving the video stream to generate a digital RGB signal or an analog RGB signal to be displayed on the display.

7. The computer system of claim 1, wherein the MPEG decoder comprises an MPEG2 decoder.

8. The computer system of claim 1, wherein the media access device comprises a DVD device.

9. The computer system of claim 8, wherein the DVD device comprises a DVD+RW.

10. The computer system of claim 1, wherein the media access device comprises a CD device.

11. The computer system of claim 10, wherein the CD device comprises a CD-RW.

12. The computer system of claim 1, wherein the media access device comprises a hard disk.

13. The computer system of claim 1, wherein the controller comprises a microprocessor.

14. A circuit having a direct media access mode, the circuit comprising:
a bus switch for receiving a bus data, wherein the bus data is generated by a media access device after the media access device accesses a media data;
an MPEG decoder for receiving the bus data from the bus switch and performing decoding, the MPEG decoder outputting a video stream to be displayed on a display; and
a controller for controlling the media access device, the MPEG decoder, and the bus switch; wherein:
the circuit has a direct media access mode and a computer mode as decided by the controller;
in the computer mode, the bus switch switches the bus data to a computer;
in the direct media access mode, the bus switch switches the bus data to the MPEG decoder;
in the computer mode, the computer is turned on; and
in the direct media access mode, the computer is turned off and the circuit is controlled by the controller.

15. The circuit of claim 14, further comprising an interface device placed between the bus switch and the MPEG decoder, wherein when the bus data is not compatible with the MPEG standard, the interface device converts the bus data into an MPEG stream compatible with the MPEG standard.

16. The circuit of claim 15, wherein the interface device comprises an interface for converting Universal Serial Bus data into the MPEG stream.

17. The circuit of claim 15, wherein the interface device comprises an interface for converting IDE data into the MPEG stream.

18. The circuit of claim 14, further comprising a digital to analog converter, the digital-to-analog converter receiving the video stream to generate a television signal to be displayed on a television.

19. The circuit of claim 14, further comprising a deinterlacer, the deinterlacer receiving the video stream to generate a digital RGB signal or an analog RGB signal to be displayed on the display.

20. The circuit of claim 14, wherein the media access device comprises a DVD device.

21. The circuit of claim 20, wherein the DVD device comprises a DVD+RW.

22. The circuit of claim 14, wherein the controller comprises a microprocessor.
